(19) United States
(12) Patent Application Publication
(10) Pub. No.: US 2014/0280618 A1
(43) Pub. Date: Sep. 18, 2014

(54) DYNAMIC ALERT RECOGNITION SYSTEM

(71) Applicant: INTERNATIONAL BUSINESS MACHINES CORPORATION, Armonk, NY (US)

(72) Inventors: Jacklin Ann Adams, New Hill, NC (US); Gegi Thomas, Piermont, NY (US)

(73) Assignee: INTERNATIONAL BUSINESS MACHINES CORPORATION, Armonk, NY (US)

(21) Appl. No.: 13/831,090

(22) Filed: Mar. 14, 2013

(51) Int. Cl. H04L 12/58

(52) U.S. Cl. CPC H04L 51/24; H04L 51/34
USPC 709/206

(57) ABSTRACT

Intelligent notification generation. Communications from various sources are received and stored in memory as individual event entries. Each event entry is dynamically assessed for generation of a notification based on criteria. This criteria is dynamic and employed by feedback generated by user input and acknowledgements from delivered notifications. Generated notifications are translated into an audio format for delivery. The delivered notification, including the status of the delivered notification and attributes of the delivered notification, are stored in memory for purposes of establishing and aligning the criteria.

### BACKGROUND

The present invention relates to a method and system for intelligent notification generation. Specifically, the invention relates to extrapolating notification generation to enable and enhance dynamic audio voice alert recognition.

### DESCRIPTION OF THE PRIOR ART

With the development of electronics, there has been an increased reliance on singular devices to store communications from a multitude of sources. These devices produce notifications to remind or alert a user of receipt of a communication. Manual selection of preferences may be enabled to parse communications from a communication source. Specifically, the preferences may be set to disable or enable receipt from select communication sources.

Even with these preference capabilities, a user can be inundated with notifications, causing unintentional loss of communications. For example, a source may be comprised of several sections or divisions, and enablement of preferences from the source entity does not necessarily filter communications within the source divisions. Preferences may be set to receive communications from a particular source, without further filtering within the source. Alternatively, a user may not manually select preferences from every communication source. Accordingly, notifications may be mismanaged due to preference configuration.

Another factor with communication management pertains to situational awareness. Specifically, the user of the device may not be capable of addressing a communication based upon the situation and environment in which the message is received. For example, a communication received during operation of a vehicle hinders the physical ability to respond to the received communication. Accordingly, management of communications remains challenging.

### SUMMARY

This invention comprises a method, system, and computer program product for autonomously generated audio notifications.

In one aspect, a method is provided for autonomous generation of audio notifications. An entry is created for a received communication and the entry is stored in memory. Separate from the receipt and storage of the communication, the entry is assessed for a notification attribute, and a first notification is generated in response to the assessment. Specifically, an event attribute is received and a tangible output is created for the notification. In one embodiment, the assessment takes place in real-time. The output is translated to an audio format, including vocal, textual, or spoken, and the notification is delivered in the audio translated format in-real time and is stored in memory.

In another aspect, a system is provided for dynamic notification generation. A data entry is created in response to a received communication, and the entry is stored in an event state log. A processing unit is provided in communication with the log, and a functional unit is provided in communication with the processing unit. The functional unit is provided with tools to support notification generation through management of the event state log. The tools include a communication manager, a notification manager, a conversion manager, and a delivery manager. The communication manager assesses the entry for a notification attribute. In one embodiment, the assessment takes place in real-time. The notification manager generates a notification in response to the assessment. Specifically, the notification manager receives an event attribute as input from the entry and creates a tangible output form for the notification. The conversion manager translates the output to an audio format. The audio format may be, and is not limited to, a vocal, textual, or spoken notification. The delivery manager delivers the notification in the translated audio format in real-time and stores the notification in memory.

In yet another aspect, a computer program product is provided for use with electronic communication data. The computer program product comprises a computer-readable non-transitory storage medium having computer readable program code embodied thereon. When executed, a computer, upon receiving a first communication, creates an entry for the communication and stores the entry in memory. Program code assesses the entry for a notification attribute in real-time. This assessment is independent from receipt and storage of the communication. Program code generates a notification in response to the assessment. Specifically, the program code receives an event attribute as input from the entry and creates a tangible output for the notification. Program code translates the output to an audio format, delivers the notification in the translated audio format in real-time, and stores the notification in the memory.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a flow chart illustrating a method for generating a system notification.

FIG. 2 is a flow chart illustrating a method for responding to a detected error in the generation of a notification.

FIG. 3 is a flow chart illustrating a method for creating a prioritized keyword list.

FIG. 4 is a flow chart illustrating a method for dynamically aligning the keyword list.

FIG. 5 is a block diagram depicting a system for autonomous notification generation.

FIG. 6 depicts a block diagram illustrating a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, modules, and/or managers. The functional unit may be implemented in programmable hardware devices such as field programmable gate arrays, programmable array logic, programmable logic devices, or the like. The functional unit may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

A received communication is referred to as an event. Each received event is processed, and an associated entry is created and stored in a log. Based upon attributes associated with the event, an alert is selectively and autonomously generated. FIG. 1 is a flow chart (100) illustrating a method for generating such alerts. As shown, a received communication (102) is processed (104). In one embodiment, the processing is conducted in real-time. Similarly, in one embodiment, the real-time processing includes processing an alert immediately upon receipt of the event. For each received event, it is determined if the event meets criteria to generate an associated alert (106). In one embodiment, the criteria include a prioritized list of names, words, and/or phrases. Similarly, in one embodiment, the criteria is dynamic in that it is adjusted responsive to feedback. As such, the criteria for one event may be different from criteria for a subsequent event. Accordingly, as communications are received, they are processed and parsed for selective assignment of an alert.

A positive response to the determination at step (106) is an indication that an alert creation is appropriate for the event under consideration. The alert is an indicator that a notification should be processed for the event. An alert attribute is created for the event (110), and both the event and the attribute are stored in the event log (112). In one embodiment, the alert includes a flag indicating that a notification should be generated for the associated event. In one embodiment, multiple alert attributes may be created for an event signaling the creation of multiple notifications for the event. Accordingly, an event meeting criteria for generating an alert is flagged with an alert attribute for notification generation.

As demonstrated at steps (108) and (112), an event alone or the event in conjunction with the alert attribute is stored in the event log, respectively. In one embodiment, the event log stores all relevant information associated with an event, including but not limited to, the status of the notification, and the attributes associated with the event. Similarly, in one embodiment the status of the event may include a current state of the notification associated with the event in the delivery process. The stored status of the event may also include a stored alert associated with the event. The event log is polled for such alerts for notification generation (114). Specifically, the polling includes searching the event log for any alerts associated with an event, and determining if any alerts are present in the log (116). A negative response is followed by waiting a designated time interval (118) followed by a return to step (116) for a subsequent polling. However, a positive response to the polling at step (116) is followed by the generation of a notification (120). Accordingly, notifications are generated for events flagged with alerts in the event state log, and the log is periodically polled to generate notifications.

When a notification is created, delivery of the notification is critical. Referring to the flow chart (200) illustrated in FIG. 2, there are two separate aspects associated with delivery of an alert, including generation of the notification and delivery thereof. As shown, it is determined if any errors occurred (204) in response to the generation of the notification (202). A positive response to the determination at step (204) is followed by identifying the error (206) and a return to step (114) to enable regeneration of the notification. A negative response is followed by a delivery of the notification (208). Accordingly, the first part of the notification process pertains to notification generation and ensuring that there are no errors associated with this process.

Following a successful generation of the notification, the notification is delivered to a recipient (208), and it is determined if there was an error in its delivery (210). If there is a delivery error, the error is identified (206), and followed by a return to step (114) for re-generation of the notification. However, if there is no delivery error, a response associated with the notification is processed (212) and stored in the event state log together with the event (214). It is common that the recipient of a notification will have some reaction to receipt thereof, it is the physical nature of the reaction, and in one embodiment non-reaction, that is stored in the event log. Following step (214), it is determined if the notification was successfully received by the intended recipient (216). In one embodiment, a successful reception of a notification is determined by an acknowledgement from the user that the notification was received. This acknowledgement is a form of verification determined from activity or inactivity of a user. A negative response to step (216) is followed by a return to step (114) for re-generation of the notification. In one embodiment, this negative response is determined by an acknowledgement in the form of inactivity of a user and is additionally followed by recording the notification in the event state log as an acknowledgment state “not successfully delivered”. Accordingly, a notification is delivered to the intended recipient and the status of the delivery is determined from an acknowledgement from the recipient.

A positive response to the determination at step (216) is followed by a recordation in the event state log (218) of the successful reception. In one embodiment, the recordation includes a derived sentiment of the user responsive to the received notification. In one embodiment, the recordation includes feedback in the form of an acknowledgement state due to activity of the user, wherein the acknowledgement state is “accepted” or “ignored”. In one embodiment, the “ignored” acknowledgement state is considered an activity of the recipient, as opposed to an inactivity of the recipient, because in this instance the recipient actively communicates that the notification was received, however, was chosen to be ignored. Accordingly, feedback in the form of an acknowledgement is acquired and recorded in the form of an acknowledgement state responsive to reception of a notification.

As shown in FIG. 1, it is determined whether a notification should be generated for an event. More specifically, criteria is established and it is determined whether this criteria is met, see step (106). In one embodiment, this criteria includes a prioritized keyword list that is subject to change in a dynamic manner. FIG. 3 is a flow chart (300) illustrating an embodiment for creating this prioritized keyword list. Communication sources are identified (302). In one embodiment, these communication sources are groups that are part of a social network. These communication sources may be activated through selection by a user, or through being embedded per a protocol. Activity in an identified communication source is processed (304). In one embodiment, the activity includes a communication within the communication source. The frequency of text within a communication is analyzed (306). This text may include but is not limited to, names, words, and/or phrases, and are hereafter known as “keywords”. These keywords are stored in a keyword list (308). In one embodiment, a keyword is prioritized within the list responsive to the frequency with which text is repeated, the perceived importance of certain keywords, or some combination thereof. Accordingly, received activity from identified sources is used to create a dynamic prioritized keyword list.

The prioritized keyword list is autonomously aligned in response to feedback generated from delivered notifications. As shown in FIG. 2, feedback is gathered and stored for each event and the associated notification in the form of acknowledgement states. FIG. 4 is a flow chart (400) illustrating a method for alignment of feedback with the prioritized keyword list. In response to delivery of a notification (402), recipient feedback is identified. Specifically, it is determined whether the message was accepted by the recipient (404). A positive response leads to the determination that the recipient valued the received notification and in one embodiment the prioritized list maintains its order of priority (not shown). In one embodiment, the positive response is followed by alignment of the prioritized list such that at least one keyword associated with the delivered notification is given higher priority in the prioritized list (not shown). A negative response to step (404) is followed by a determination as to whether the notification was actively ignored (406). A negative response to the determination at step (406) is followed by a termination of the method, and a positive response is followed by alignment of the prioritized list such that at least one keyword associated with the delivered notification is given lower priority in the prioritized list (408). Accordingly, the prioritized keyword list is dynamically aligned responsive to feedback from delivered notifications.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 5 is a block diagram (500) depicting a system for intelligent notification generation. A computer (502) is provided in communication with data storage (550). The data storage stores an event state log (552) to track events and their attributes. In one embodiment, the event state log (552) is in communication with a prioritized keyword list (554) holding event attributes. The computer (502) is provided with a processing unit (504) in communication with memory (510) across a bus (506). A functional unit (520) is provided in communication with memory and includes tools to support dynamic criteria for the autonomous generation and delivery of audible notifications. These tools include a communication manager (522), a notification manager (524), a conversion manager (526), and a delivery manager (528). In one embodiment, a feedback manager (530) and an activation manager (532) are further included in the tools.

The communication manager (522) is provided to manage entries in the event state log. More specifically, the communication manager (522) individually assesses entries in the data entry log and determines whether each entry meets necessary dynamic criteria to generate a notification. Upon assessment of a received and stored second communication for instance, the criteria to assess the second communication is sensitive to the received and stored feedback from a first notification. In one embodiment, the communication manager (522) assesses communications from a social network. In one embodiment, for the communication manager (522) to assess a communication from a social network, the social network is first activated by an activation manager (532). In this embodiment, the activation manager activates a social network responsive to a selection of a user, or an embedded protocol. The communication assessment includes comparison of the communication to a prioritized keyword list in communication with the event state log. Accordingly, the communication manager (522) assesses communications stored in or in communication with the event state for notification generation.

If the necessary criteria is met, the notification manager (524), provided in communication with the communication manager (522), generates a notification responsive to the assessment. In one embodiment, the notification manager (524) generates a notification upon matching a keyword in the entry with a keyword in the prioritized keyword list. Specifically, the notification manager (524) receives an event attribute as input from the created entry and creates a tangible output form for the notification. The conversion manager (526), provided in communication with the notification manager (524), translates the output to an audio format. The delivery manager (528), provided in communication with the conversion manager (526), delivers the notification in this translated audio format. In one embodiment, the delivery manager (528) delivers the notification in real-time, which includes delivery of the notification immediately after conversion of the notification to an audio format. Accordingly, the tools generate a notification, convert the notification to an audible format, and deliver the notification.

The feedback manager (530), provided in communication with the delivery manager (528), receives feedback associated with the delivered notification. The feedback manager (530) stores the received feedback in the event state log with the first communication. In one embodiment, this feedback includes a delivery state, the delivery state being “not successfully delivered”, “accepted”, or “ignored”. In one embodiment, the notification manager (524) re-generates the notification responsive to a negative sentiment associated with the notification in the stored feedback. In a further embodiment, the feedback manager (530) aligns the prioritized keyword list responsive to the stored feedback. The feedback manager (530) receives and stores feedback responsive to a delivered notification. Accordingly, the tools support dynamic assessment of criteria together with real-time generation and delivery of audio formatted notifications.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Referring now to the block diagram (600) of FIG. 6, additional details are now described with respect to implementing an embodiment of the present invention. The computer system includes one or more processors, such as a processor (602). The processor (602) is connected to a communication infrastructure (604) (e.g., a communications bus, cross-over bar, or network).

The computer system can include a display interface (606) that forwards graphics, text, and other data from the communication infrastructure (604) (or from a frame buffer not shown) for display on a display unit (608). The computer system also includes a main memory (610), preferably random access memory (RAM), and may also include a secondary memory (612). The secondary memory (612) may include, for example, a hard disk drive (614) (or alternative persistent storage device) and/or a removable storage drive (616), representing, for example, a floppy disk drive, a magnetic tape drive, or an optical disk drive. The removable storage drive (616) reads from and/or writes to a removable storage unit (618) in a manner well known to those having ordinary skill in the art. Removable storage unit (618) represents, for example, a floppy disk, a compact disc, a magnetic tape, or an optical disk, etc., which is read by and written to by a removable storage drive (616). As will be appreciated, the removable storage unit (618) includes a computer readable medium having stored therein computer software and/or data.

In alternative embodiments, the secondary memory (612) may include other similar means for allowing computer programs or other instructions to be loaded into the computer system. Such means may include, for example, a removable storage unit (620) and an interface (622). Examples of such means may include a program package and package interface (such as that found in video game devices), a removable memory chip (such as an EPROM, or PROM) and associated socket, and other removable storage units (620) and interfaces (622) which allow software and data to be transferred from the removable storage unit (620) to the computer system.

The computer system may also include a communications interface (624). Communications interface (624) allows software and data to be transferred between the computer system and external devices. Examples of communications interface (624) may include a modem, a network interface (such as an Ethernet card), a communications port, or a PCMCIA slot and card, etc. Software and data transferred via communications interface (624) are in the form of signals which may be, for example, electronic, electromagnetic, optical, or other signals capable of being received by communications interface (624). These signals are provided to communications interface (624) via a communications path (i.e., channel) (626). This communications path (626) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (610) and secondary memory (612), removable storage drive (616), and a hard disk installed in hard disk drive or alternative persistent storage device (614).

Computer programs (also called computer control logic) are stored in main memory (610) and/or secondary memory (612). Computer programs may also be received via a communication interface (624). Such computer programs, when run, enable the computer system to perform the features of the present invention as discussed herein. In particular, the computer programs, when run, enable the processor (602) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. Specifically, intelligent notification generation may be extended to any electronic device, and is not limited to a mobile device. Accordingly, the scope of protection of this invention is limited only by the following claims and their equivalents.

We claim:

1. A method comprising:
in response to receiving a first communication, creating an entry for the received communication and storing the created entry in memory;
assessing the created entry for a notification attribute in real-time the assessment being independent from receipt and storage of the communication;
generating a first notification in response to the assessment, including receiving an event attribute as input from the created entry and creating a tangible output for the notification;
translating the output to an audio format, wherein the audio format is selected from the group consisting of: voice, text, and speech; and
delivering the notification in the translated audio format in real-time, and storing the notification in the memory.

2. The method of claim 1, further comprising receiving feedback associated with the delivered notification and storing the feedback with the first communication entry.

3. The method of claim 2, further comprising assessing a received and stored second communication for the notification attribute, the assessment including the received and stored feedback from the first notification.

4. The method of claim 2, wherein the feedback includes an acknowledgement state selected from the group consisting of: not successfully delivered, accepted, and ignored.

5. The method of claim 4, further comprising re-generating the first notification in response to a negative sentiment for the stored feedback.

6. The method of claim 1, further comprising applying the assessment to a social network wherein the assessment comprises a prioritized keyword list, including comparing the created entry with the prioritized keyword list, and generating the notification upon matching a keyword in the entry with a keyword in the prioritized keyword list.

7. The method of claim 6, further comprising activating the social network, the activation selected from the group consisting of: selected by the user, and embedded per a protocol.

8. The method of claim 6, further comprising receiving feedback associated with the delivered notification, storing the feedback with the first communication entry, and aligning the prioritized keyword list responsive to the stored feedback.

9. A system comprising:
an event state log to store at least one data entry;
a processing unit in communication with the event state log, an entry in the event state log created for a received communication;
a functional unit in communication with the processing unit, the functional unit having tools to support intelligent notification generation through management of the event state log, the tools comprising:
a communication manager to assess the created entry for a notification attribute in real-time;
a notification manager in communication with the communication manager, the notification manager to generate a first notification in response to the assessment, including the notification manager to receive an event attribute as input from the created entry and to create a tangible output form for the notification;
a conversion manager in communication with the notification manager, the conversion manager to translate the output to an audio format, wherein the audio is selected from the group consisting of: voice, text, and speech; and
a delivery manager in communication with the conversion manager, the delivery manager to deliver the notification in the translated audio format in real time, and store the notification in memory.

10. The system of claim 9, further comprising a feedback manager in communication with the delivery manager, the feedback manager to receive feedback associated with the delivered notification and to store the feedback with the first communication entry in the event state log.

11. The system of claim 9, further comprising the communication manager to assess a received and stored second communication for the notification attribute, the assessment including the received and stored feedback from the first notification.

12. The system of claim 9, wherein the feedback includes a delivery state selected from the group consisting of: not successfully delivered, accepted, and ignored.

13. The system of claim 9, further comprising the communication manager to apply the assessment to a social network, wherein the assessment comprises a prioritized keyword list stored in the event state log, including the communication manager to compare the created entry with the prioritized keyword list, and generate the notification upon matching a keyword in the entry with a keyword in the prioritized keyword list.

14. The system of claim 13, further comprising a feedback manager in communication with the delivery manger, the feedback manager to receive feedback associated with the delivered notification, store the feedback with the first communication entry, and align the prioritized keyword list responsive to the stored feedback.

15. A computer program product for use with electronic communication data, the computer program product comprising a computer-readable non-transitory storage medium having a computer readable program code embodied thereon, which when executed causes a computer to implement the method comprising:
in response to receiving a first communication, creating an entry for the received communication and storing the created entry in memory;
assessing the created entry for a notification attribute in real-time, the assessment being independent from receipt and storage of the communication;
generating a first notification in response to the assessment, including receiving an event attribute as input from the created entry and creating a tangible output for the notification;
translating the output to an audio format; and
delivering the notification in the translated audio format in real-time and storing the notification in the memory.

16. The computer program product of claim 15, further comprising the computer program product to receive feedback associated with the delivered notification and to store the feedback with the first communication entry.

17. The computer program product of claim 16, further comprising the computer program product to assess a received and stored second communication for the notification attribute, the assessment including the received and stored feedback from the first notification.

18. The computer program product of claim 16, wherein the feedback includes an acknowledgement state selected from the group consisting of: not successfully delivered, accepted, and ignored.

19. The computer program product of claim 18, further comprising the computer program product to regenerate the first notification in response to a negative sentiment for the stored feedback.

20. The computer program product of claim 15, further comprising the computer program product to apply the assessment to a social network, wherein the assessment comprises a prioritized keyword list, including the computer program product to compare the created entry with the prioritized keyword list, and generate the notification upon matching a keyword in the entry with a keyword in the prioritized keyword list.
